(19) United States
(12) Patent Application Publication
(10) Pub. No.: US 2003/0235356 A1
(43) Pub. Date: Dec. 25, 2003

(54) Bottom bracket assembly for bicycles

(76) Inventor: Cheng-Xun Jiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/176,670

(22) Filed: Jun. 24, 2002

(51) Int. Cl. F16C 9/00

(52) U.S. Cl. 384/458

(57) ABSTRACT

A bottom bracket assembly includes an axle with two flanges on an outer periphery close to a first end of the axle and two bearings are mounted to the axle and engaged with the two flanges. A flange extends from the outer periphery of the axle and is located close to a second end of the axle. A bearing is mounted to the axle and engaged with the flange. Each bearing is retained by a retaining ring such that the axle is rotated smoothly.

### FIELD OF THE INVENTION

The present invention relates to a bottom bracket assembly for bicycles wherein two bearings are mounted close to one end of the axle and positioned by two flanges and the other end of the axle has one bearing. The arrangement of the bearings ensures that axle to rotate smoothly.

### BACKGROUND OF THE INVENTION

A conventional bottom bracket assembly for bicycles generally includes an axle with two bearings mounted thereto and two cranks are connected to two ends of the axle. The bottom bracket assembly is too heavy so that many efforts have made to reduce the weight of the conventional bottom bracket assembly. A hollow axle is used to replace the conventional solid axle and in order to install the two bearings to two ends of the axle, each end of the axle has an enlarged cup in which the bearing is received. However, the single bearing on each end of the axle does not provide sufficient support to the load on the axle so that the axle could be deformed after being used for a period of time. Besides, a gap could be formed when installing the bearings to the enlarged cups and noise generates when the bottom bracket assembly is operated.

The present invention intends to provide a bottom bracket assembly wherein the axle is supported by three sets of bearing.

### SUMMARY OF THE INVENTION

In accordance with one aspect of the present invention, there is provided a bottom bracket assembly which comprises an axle received in a bottom bracket and has two first flanges extending radially outward from an outer periphery of the axle and located close to a first end of the axle. A second flange extends radially outward from the outer periphery of the axle and located close to a second end of the axle.

Two first bearings are mounted to the axle and engaged with the two first flanges respectively. Two first retaining rings are respectively mounted to the two first bearings. A second bearing is mounted to the axle and engaged with the second flange. A second retaining ring is mounted to the second bearing.

An outer tube is mounted to the axle and engaged between one of the first retaining rings and the second retaining ring. Two locking members are respectively connected to two ends of a bottom bracket so as to position the axle.

The primary object of the present invention is to provide a bottom bracket assembly that has bearings mounted on the axle such that the axle is rotated smoothly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a bottom bracket assembly of the present invention;

FIG. 2 is a cross sectional view to show the bottom bracket assembly of the present invention;

FIG. 3 is a perspective view to show the bottom bracket assembly of the present invention with a part of the bottom bracket removed, and

FIG. 4 is a perspective view to show the bottom bracket assembly of the present invention.

### DETAILED DESCRIPTION OF THE PREFERRED EMBODIMENT

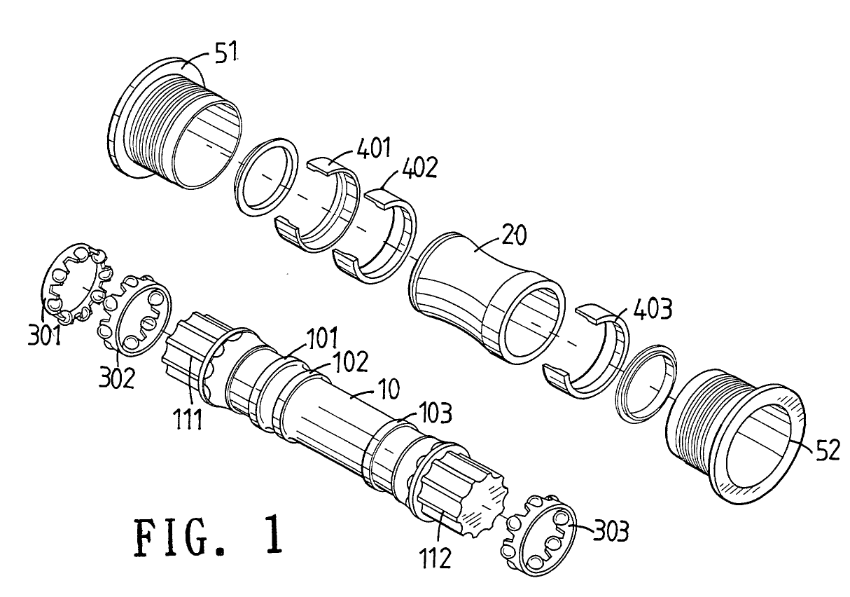

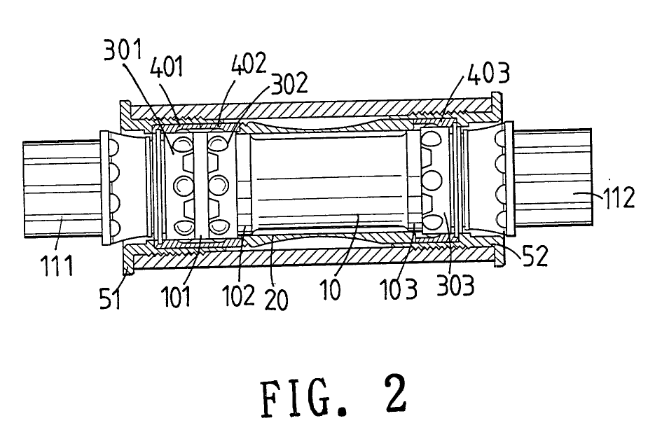

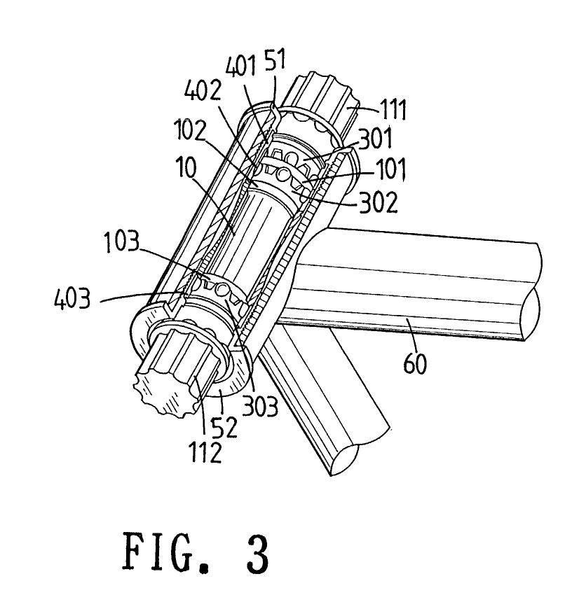

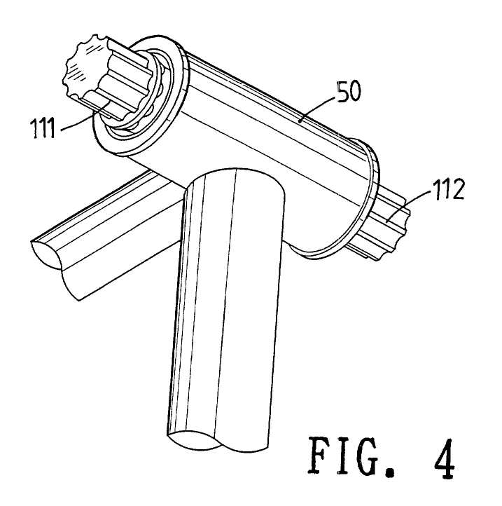

Referring to FIGS. 1 to 4, the bottom bracket assembly of the present invention comprises an axle 10 which is received in a bottom bracket 50 of a bicycle and each end of the axle 10 has a connection end 111, 112 for cranks (not shown) connected to the two connection ends 111, 112 respectively. Two first flanges 101, 102 extend radially outward from an outer periphery of the axle 10 and are located close to a first end of the axle 10. A second flange 103 extends radially outward from the outer periphery of the axle 10 and the second flange 103 is located close to a second end of the axle 10.

Two first bearings 301, 302 are mounted to the axle 10 and engaged with the two first flanges 101, 102 respectively. A second bearing 303 is mounted to the axle 10 and engaged with the second flange 103.

Two first retaining rings 401, 402 are respectively mounted to the two first bearings 301, 302, and a second retaining ring 403 is mounted to the second bearing 303. An outer tube 20 is mounted to the axle 10 and engaged between one of the first retaining rings 401, 402 and the second retaining ring 403 as shown.

Two locking members 51, 52 each have a threaded section which is threadedly connected to an inner periphery of the two ends of the bottom bracket 50. The adapted to be connected to two ends of a bottom bracket so as to position the axle 10.

The 10 is well supported by the bearings 301, 302 and 303, and each bearing 301/302/303 is retained by respective retaining ring 401/402/403 so that the axle 10 is rotated smoothly and the structural strength of the whole bottom bracket assembly is reinforced.

While we have shown and described the embodiment in accordance with the present invention, it should be clear to those skilled in the art that further embodiments may be made without departing from the scope of the present invention.

What is claimed is:

1. A bottom bracket assembly comprising:
an axle adapted to be received in a bottom bracket and having two first flanges extending radially outward from an outer periphery of the axle, the two first flanges located close to a first end of the axle, a second flange extending radially outward from the outer periphery of the axle and the second flange located close to a second end of the axle;
two first bearings mounted to the axle and engaged with the two first flanges respectively, a second bearing mounted to the axle and engaged with the second flange;
two first retaining rings respectively mounted to the two first bearings, a second retaining ring mounted to the second bearing;
an outer tube mounted to the axle and engaged between one of the first retaining rings and the second retaining ring, and
two locking members respectively adapted to be connected to two ends of a bottom bracket so as to position the axle.
